(19) United States
(12) Patent Application Publication
(10) Pub. No.: US 2026/0211543 A1
(43) Pub. Date: Jul. 23, 2026

(54) OBJECT MOVEMENT CONTROL METHOD AND APPARATUS, DEVICE AND MEDIUM

(71) Applicant: Beijing Zitiao Network Technology Co., Ltd., Beijing (CN)

(72) Inventor: Chin-Wei LIU, Beijing (CN)

(21) Appl. No.: 19/142,505

(22) PCT Filed: Nov. 20, 2023
(86) PCT No.: PCT/CN2023/132539

§ 371 Date: Jun. 23, 2025

(30) Foreign Application Priority Data
Dec. 22, 2022 (CN) 202211658154.0

(51) Int. Cl. G06F 3/04845; G06F 3/01; G06F 3/04842

(52) U.S. Cl. CPC G06F 3/04845; G06F 3/017; G06F 3/04842

(57) ABSTRACT

Embodiments of the present disclosure relate to a method, an apparatus, a device, and a medium for object movement control. The method includes the following steps: in response to a hand posture in an extended reality space being a preset selection gesture, determining a target object corresponding to the preset selection gesture in the extended reality space; in response to the hand posture changing from the preset selection gesture to a preset selection confirmation gesture, detecting current hand motion information; and in response to detecting the current hand motion information, performing movement control processing on the target object according to the current hand motion information.

### CROSS-REFERENCE TO RELATED APPLICATION(S)

The present application claims priority to Chinese Patent Application No. 202211658154.0, filed on Dec. 22 2022 and entitled “OBJECT MOVEMENT CONTROL METHOD AND APPARATUS, DEVICE, AND MEDIUM”, which is hereby incorporated by reference in its entirety.

### FIELD

The present disclosure relates to the field of extended reality technologies and, in particular, to a method and apparatus, a device, and a medium for object movement control.

### BACKGROUND

Extended reality (XR) refers to combining the real and the virtual through a computer to create a virtual environment in which human-computer interaction can be performed. XR is also a generic term for various technologies such as augmented reality (AR), virtual reality (VR), and mixed reality (MR). By integrating the visual interaction technologies of the three, experiencers can get an “immersive” experience of seamless switching between a virtual world and the real world. Among them, improving the intelligence of operations in an extended reality scene has become a mainstream.

In the related technologies, an extended reality scene can be used to implement movement control of a related object in the extended reality scene based on a control operation of a user on a control of a manipulation device such as a manipulation handle. This method for controlling the object is not interactive.

### SUMMARY

In order to solve the above technical problems or at least partially solve the above technical problems, the present disclosure provides a method, an apparatus, a device, and a medium for object movement control, which implement controlling the movement of an object according to a hand posture and hand movement, implement “bare hand” control to the object, improve the flexibility of object movement control, and improve the interaction experience in an extended reality space.

An embodiment of the present disclosure provides a method for object movement control, including the following steps: in response to a hand posture in an extended reality space being a preset selection gesture, determining a target object corresponding to the preset selection gesture in the extended reality space; in response to the hand posture changing from the preset selection gesture to a preset selection confirmation gesture, detecting current hand motion information; and in response to detecting the current hand motion information, performing movement control processing on the target object according to the current hand motion information.

An embodiment of the present disclosure further provides an apparatus for object movement control, including: a determination module, configured to determine, in response to a hand posture in an extended reality space being a preset selection gesture, a target object corresponding to the preset selection gesture in the extended reality space; a detection module, configured to detect current hand motion information in response to the hand posture changing from the preset selection gesture to a preset selection confirmation gesture; and a movement control module, configured to perform movement control processing on the target object according to the current hand motion information in response to detecting the current hand motion information.

An embodiment of the present disclosure further provides an electronic device, including: a processor; a memory configured to store instructions executable by the processor; and the processor is configured to read the executable instructions from the memory and execute the instructions to implement the method for object movement control as provided in the embodiments of the present disclosure.

An embodiment of the present disclosure further provides a computer-readable storage medium, storing a computer program, which is configured to execute the method for object movement control as provided in the embodiments of the present disclosure.

An embodiment of the present disclosure further provides a computer program product, when instructions in the computer program product are executed by a processor, causing the processor to perform the object movement control method as provided in the embodiments of the present disclosure.

Compared with the prior art, the technical solution provided in the embodiments of the present disclosure has the following advantages:

In the object movement control solution provided in the embodiments of the present disclosure, in response to a hand posture in an extended reality space being a preset selection gesture, a target object corresponding to the preset selection gesture is determined in the extended reality space; in response to the hand posture changing from the preset selection gesture to a preset selection confirmation gesture, current hand motion information is detected; and in response to detecting the current hand motion information, movement control processing is performed on the target object according to the current hand motion information. In the embodiments of the present disclosure, the movement of the object is controlled according to the hand posture and hand movement, the “bare hand” control to the object is implemented, the flexibility of object movement control is improved, and the interaction experience in the extended reality space is improved.

### BRIEF DESCRIPTION OF THE DRAWINGS

The above and other features, advantages, and aspects of various embodiments of the present disclosure will become more apparent with reference to the following specific embodiments in combination with the drawings. Throughout the drawings, the same or similar reference numerals denote the same or similar elements. It should be understood that the drawings are schematic and that parts and elements are not necessarily drawn to scale.

FIG. 1 is a schematic diagram of an application scene of a virtual reality device according to an embodiment of the present disclosure;

FIG. 2 is a schematic flowchart of a method for object movement control according to an embodiment of the present disclosure;

FIG. 3 is a schematic diagram of positions of hand key-points according to an embodiment of the present disclosure;

FIG. 4 is a schematic diagram of a hand posture according to an embodiment of the present disclosure;

FIG. 5 is a schematic diagram of an indication of a bending degree corresponding to a hand key-point according to an embodiment of the present disclosure;

FIG. 6A is a schematic diagram of an object movement control scene according to an embodiment of the present disclosure;

FIG. 6B is a schematic diagram of another object movement control scene according to an embodiment of the present disclosure;

FIG. 7 is a schematic diagram of another object movement control scene according to an embodiment of the present disclosure;

FIG. 8A is a schematic diagram of another object movement control scene according to an embodiment of the present disclosure;

FIG. 8B is a schematic diagram of another object movement control scene according to an embodiment of the present disclosure;

FIG. 8C is a schematic diagram of another object movement control scene according to an embodiment of the present disclosure;

FIG. 8D is a schematic diagram of another object movement control scene according to an embodiment of the present disclosure;

FIG. 9 is a schematic flowchart of another method for object movement control according to an embodiment of the present disclosure;

FIG. 10 is a schematic diagram of another object movement control scene according to an embodiment of the present disclosure;

FIG. 11 is a schematic diagram of another object movement control scene according to an embodiment of the present disclosure;

FIG. 12 is a schematic structural diagram of an apparatus for object movement control according to an embodiment of the present disclosure; and

FIG. 13 is a schematic structural diagram of an electronic device according to an embodiment of the present disclosure.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure can be implemented in various forms and should not be construed as being limited to the embodiments set forth herein. On the contrary, these embodiments are provided for a more thorough and complete understanding of the present disclosure. It should be understood that the drawings and the embodiments of the present disclosure are only for illustrative purposes and are not intended to limit the protection scope of the present disclosure.

It should be understood that various steps described in the method implementations of the present disclosure can be performed in different orders and/or in parallel. In addition, the method implementations can include additional steps and/or omit performing the illustrated steps. The scope of the present disclosure is not limited in this respect.

The term “include” used herein and the variations thereof are open-ended inclusions, that is, “include but not limited to”. The term “based on” is “at least partially based on”. The term “an embodiment” means “at least one embodiment”; the term “another embodiment” means “at least one other embodiment”; and the term “some embodiments” means “at least some embodiments”. Related definitions of other terms will be given in the following description.

It should be noted that concepts such as “first” and “second” mentioned in the present disclosure are only used to distinguish different apparatuses, modules, or units and are not used to limit the sequence or interdependence of functions performed by these apparatuses, modules, or units.

It should be noted that the modifiers “a/an” and “a plurality of” mentioned in the present disclosure are illustrative and not restrictive. Those skilled in the art should understand that unless the context clearly indicates otherwise, these modifiers should be understood as “one or more”.

The names of messages or information exchanged among apparatuses in the implementations of the present disclosure are only used for illustrative purposes, and are not used to limit the scope of the messages or information.

In order to solve the above problem, an embodiment of the present disclosure provides a method for object movement control, which is described below with reference to specific embodiments.

Some technical concepts or noun concepts involved in this disclosure are explained below.
AR: An AR setting refers to a simulated setting in which at least one virtual object is superimposed on a physical setting or a representation thereof. For example, an electronic system may have an opaque display and at least one imaging sensor, and the imaging sensor is configured to capture an image or a video of the physical setting, which are representations of the physical setting. The system combines the image or the video with the virtual object and displays the combination on the opaque display. An individual uses the system to indirectly view the physical setting via the image or the video of the physical setting and observes the virtual object superimposed on the physical setting. When the system uses one or more image sensors to capture images of the physical setting and uses those images to present the AR setting on the opaque display, the displayed images are referred to as video see-through. Alternatively, an electronic system for displaying the AR setting may have a transparent or semi-transparent display through which the individual can directly view the physical setting. The system may display the virtual object on the transparent or semi-transparent display so that the individual uses the system to observe the virtual object superimposed on the physical setting. For another example, the system may include a projection system that projects the virtual object onto the physical setting. The virtual object may be projected, for example, on a physical surface or as a hologram so that the individual uses the system to observe the virtual object superimposed on the physical setting. Specifically, the technique is used for calculating camera posture parameters of a camera in a real world (or a three-dimensional world or a physical world) in real time during an image acquisition process of the camera, and adding a virtual object to the image acquired by the camera according to the camera posture parameters. The virtual object includes but is not limited to a three-dimensional model. The goal of the AR technology is to sleeve a virtual world onto a real world on a screen for interaction.
MR: MR presents extended reality scene information in a real scene, and builds an interactive feedback information loop among the real world, a virtual world, and a user, so as to enhance the realness of user experience. For example, the integration of sensory input created by a computer (e.g., a virtual object) and sensory input or a representation thereof from a physical setting in a simulated setting, in some MR settings, the sensory input created by the computer may be adapted to changes in the sensory input from the physical setting. In addition, some electronic systems for presenting the MR setting may monitor an orientation and/or a position relative to the physical setting, so that the virtual object can interact with a real object (i.e., a physical element from the physical setting or a representation thereof). For example, the system may monitor motion, so that a virtual plant appears to be stationary relative to a physical building.
VR: VR is a technology for creating and experiencing a virtual world, a virtual environment is generated through computing, and the virtual environment is multi-source information (the virtual reality mentioned herein includes at least visual perception, and may further include auditory perception, tactile perception, motion perception, and even taste perception, olfactory perception, and the like), implementing the simulation of a fusion interactive three-dimensional dynamic scene and entity behavior of the virtual environment, and allowing a user to be immersed in the simulated virtual reality environment, so as to implement applications of various virtual environments such as maps, games, videos, education, medical care, simulation, collaborative training, sales, assisting manufacturing, maintenance, and repair.

A virtual reality device, which is a terminal for implementing a virtual reality effect in VR, may usually be provided in the form of eyeglasses, a head-mounted display (HMD), or contact lenses, to implement visual perception and other forms of perception. Of course, the form implemented by the virtual reality device is not limited thereto, and the virtual reality device may be further miniaturized or enlarged as required.

The virtual reality devices described in the embodiments of the present disclosure may include but are not limited to the following types:

A computer-side virtual reality (PCVR) device, which uses a PC-side to perform related calculations for virtual reality functions and data output, and an external computer-side virtual reality device uses data output by the PC-side to implement a virtual reality effect.

A mobile virtual reality device, which supports setting a mobile terminal (such as a smartphone) in various ways (such as a head-mounted display with a dedicated card slot), and the mobile terminal performs related calculations for virtual reality functions through a wired or wireless connection with the mobile terminal and outputs data to the mobile virtual reality device. For example, a virtual reality video is viewed through an APP of the mobile terminal.

An all-in-one virtual reality device has a processor for performing related calculations of a virtual function, and thus has independent virtual reality input and output functions, and it does not need to be connected to a PC-side or a mobile terminal, and has high usage freedom.

An object, which is an object that interacts in an extended reality scene, is controlled by a user or a robot program (for example, a robot program based on artificial intelligence), and is an object that can be static, move, and perform various behaviors in the extended reality scene, such as a virtual person corresponding to a user in a virtual live streaming scene.

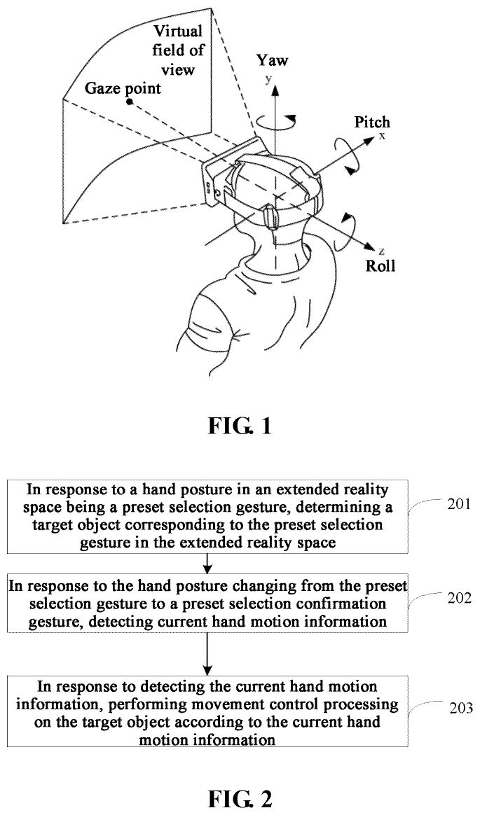

Taking a VR scene as an example, as shown in FIG. 1, the HMD is relatively light, ergonomically comfortable, and provides high-resolution content with low latency. The virtual reality device is provided with a sensor for posture detection (such as a nine-axis sensor) to detect the posture change of the virtual reality device in real time. If the user wears the virtual reality device, when the head posture of the user changes, a real-time posture of the head is transmitted to the processor, so as to calculate a gaze point of the eyesight of the user in the virtual environment, calculate an image within the gaze range of the user (i.e., a virtual field of view) in a three-dimensional model of the virtual environment according to the gaze point, and display the image on a display screen, so that people have an immersive experience as if they were watching in a real environment.

In this embodiment, when a user wears an HMD Mark's Device (HMD) device and opens a predetermined application, such as a live video streaming application, the HMD device may run a corresponding virtual scene. The virtual scene may be a simulated environment of the real world, a semi-simulated and semi-fictional virtual scene, or a purely fictional virtual scene. The virtual scene may be any of a two-dimensional virtual scene, a 2.5-dimensional virtual scene, or a three-dimensional virtual scene, and the dimension of the virtual scene is not limited in the embodiments of the present disclosure. For example, the virtual scene may include people, the sky, land, the ocean, and the like, and the land may include environmental elements such as deserts and cities. The user can control a related object in the virtual scene to move in the virtual scene, and can also use a handle device, a bare hand gesture, and other methods to interactively control objects such as controls, models, display content, and characters in the virtual scene.

As mentioned above, if the movement of the virtual object in the extended reality scene is controlled based on the handle device, the control is obviously not intelligent enough. Therefore, in order to further improve the control experience, the present disclosure proposes a method for controlling the movement of the object based on a gesture operation and hand movement. This method implements “bare hand” control to the target object and improves the interaction experience during the control process.

The following describes the method with reference to specific embodiments.

FIG. 2 is a schematic flowchart of a method for object movement control according to an embodiment of the present disclosure. The method can be performed by an apparatus for object movement control, and the apparatus can be implemented in software and/or hardware and can generally be integrated into an electronic device. As shown in FIG. 2, the method includes the following steps.

Step 201: in response to a hand posture in an extended reality space being a preset selection gesture, determining a target object corresponding to the preset selection gesture in the extended reality space.

The target object may be any object with a movement attribute displayed in the extended reality scene, such as the aforementioned person, control, model, or the like.

In an embodiment of the present disclosure, a hand image of a user's hand is captured, for example, a hand image within the range of eyesight is captured by a camera in a virtual reality device, and the hand posture is identified according to the hand image. In this embodiment, the hand posture may be identified based on an image identification method.

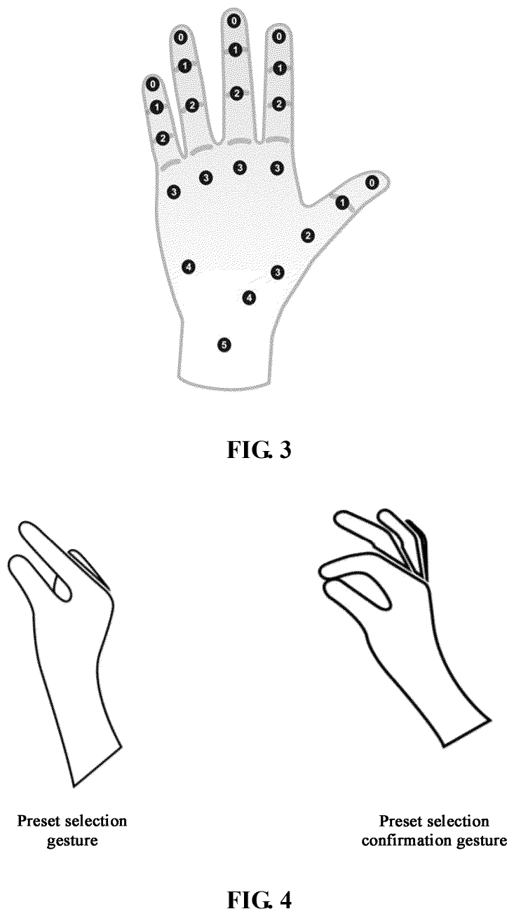

In some optional embodiments, the hand key-points are predefined. For example, as shown in FIG. 3, the hand key-points are defined according to positions of hand joint-points of the user's hand, the positions of hand key-points of the user's hand are identified, and the hand posture is identified according to the positions of the hand key-points.

The positional relationship of the hand key-points can be set according to the pre-defined identification for controlling the hand posture of the target object, so that the hand posture can be identified according to the positions of the hand key-points.

In some possible embodiments, if the control of the hand posture of the target object is related to a bending degree of a first preset finger and a distance between the first preset finger and a second preset finger, for example, if the first preset finger is an index finger and the second preset finger is a thumb, as shown in FIG. 4, the preset selection gesture is that the distance between the index finger and the thumb is relatively large (for example, greater than or equal to 3 cm) and the bending degree of the index finger is relatively small, and the preset selection confirmation gesture is that the bending degree of the index finger is relatively large and the index finger and the thumb overlap (or the distance between the index finger and the thumb is less than or equal to 1 cm).

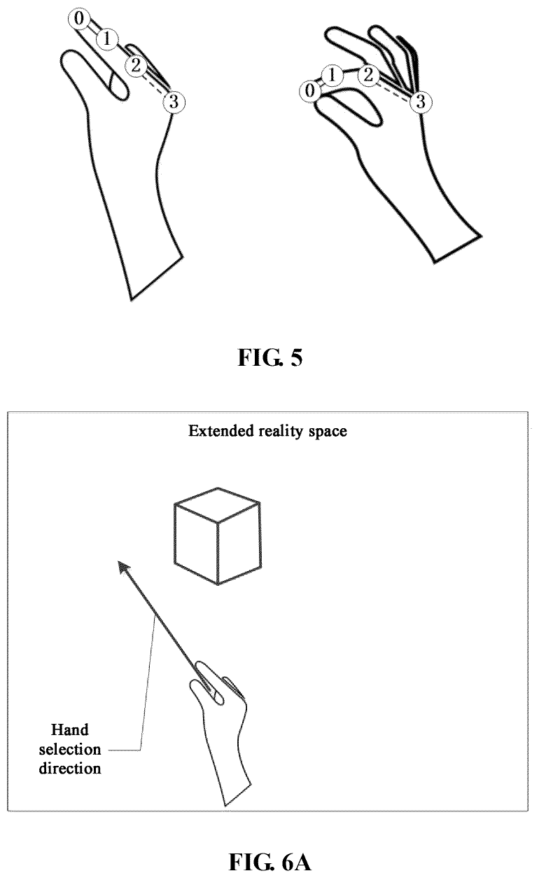

In this embodiment, the bending degree of the first preset finger in the user's hand is determined according to the positions of the hand key-points. For example, as shown in FIG. 5, an angle between a line where the finger key-points 0 and 1 of the first preset finger are located and a line where the finger key-points 2 and 3 of the first preset finger are located may be used as the bending degree of the first preset finger (only the line where the finger key-points 0 and 1 are located and the line where the finger key-points 2 and 3 are located are shown in the figure).

In this embodiment, a key-point distance between an interphalangeal key-point of the first preset finger and an interphalangeal key-point of the second preset finger is determined according to the positions of the hand key-points, so as to determine the hand posture according to the distance between the key-points.

In an embodiment of the present disclosure, in response to identifying that the hand posture in the extended reality space is the preset selection gesture, the target object corresponding to the preset selection gesture is determined in the extended reality space, to facilitate further movement control of the target object. The preset selection gesture is a pre-defined gesture for “selecting” the target object.

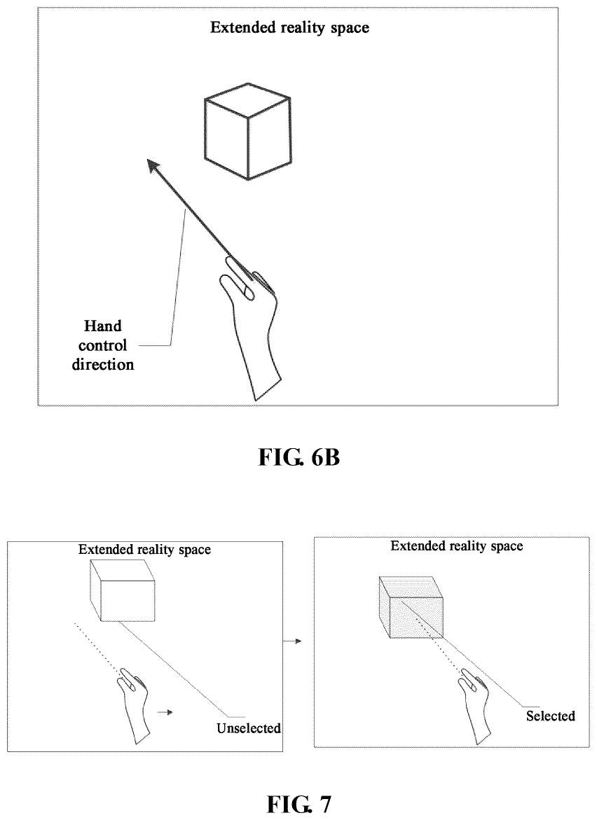

In an actual execution process, in order to further intuitively indicate a selection process of the target object, a hand control direction corresponding to the hand posture is determined, and the control object located in the hand control direction is determined as the target object. The hand control direction may be determined according to a position of a finger in the preset selection gesture, for example, as shown in FIG. 6A, if the preset selection gesture is a “grasping gesture”, the corresponding hand control direction may be a direction corresponding to a center point position of the thumb and the index finger.

Of course, in other optional embodiments, the hand control direction may also be determined according to positions of some key-points of a certain finger. For example, as shown in FIG. 6B, if the preset selection gesture is a “grasping gesture”, the corresponding hand control direction may be determined by key-point positions corresponding to the last two joints of the index finger. In other optional embodiments, the hand indication direction may also be determined in other manners, which are not listed here one by one.

Further, after the hand control direction corresponding to the hand posture is determined, the control object located in the hand control direction is determined as the target object, where the target object may be understood as a movable object closest to the hand of the user in the hand control direction.

In the embodiment of the present disclosure, in order to give an intuitive indication to the user for selecting the target object, a direction indication model corresponding to the hand indication direction may be displayed, where the direction indication model starts from a real-time hand position of the user's hand and extends and displays according to the hand indication direction. When the hand posture is the preset selection gesture, the direction indication model is displayed in the extended reality space, where the direction indication model is used for indicating the hand control direction (i.e., the hand indication direction) of the hand posture, and the control object located in the hand control direction indicated by the direction indication model is determined as the target object.

The direction indication model is used for intuitively indicating the hand control direction corresponding to the current hand posture, so that the user can adjust the hand position to select the target object that he/she wants to select. The direction indication model may be any model that can implement a direction guidance function, including but not limited to a “ray trajectory model”, a “parabola model”, a “Bezier curve model”, etc. With continued reference to FIG. 6A and FIG. 6B, the direction indication model is the “ray trajectory model”, which extends along the hand indication direction starting from the position where the hand is located, so that it is convenient for the user to know the object selection direction corresponding to the current hand posture in the extended reality scene.

Step 202: in response to the hand posture changing from the preset selection gesture to a preset selection confirmation gesture, detecting current hand motion information.

In an embodiment of the present disclosure, in response to the hand posture changing from the preset selection gesture to the preset selection confirmation gesture, determining that the target object is selected, and thus, detecting the current hand motion information, to control the movement of the target object according to the hand motion information. The hand motion information may be determined by capturing a hand image through a camera, calculating pixel displacement according to the hand image, performing coordinate conversion to a world coordinate system according to the pixel displacement, and determining the hand motion information according to a conversion result. The hand motion information includes but is not limited to a motion displacement, a motion direction, a motion speed, and the like of the hand.

In order to further improve the intuitive feeling for selecting the target object, after the target object is selected, the target object may be controlled to be displayed in a selected state, where the display of the target object in the selected state is visually distinct from the display of the target object in the non-selected state, and the display mode corresponding to the selected state may be set according to the requirements of the scene, including but not limited to highlighting the target object, displaying a text prompt of “selected” above the target object, and the like.

In some possible embodiments, as shown in FIG. 7, if the target object is a “cube”, after the “cube” is selected, it may be displayed in a “highlighted” state (in the figure, a “highlighted” state is indicated by an increase in a grayscale value) to prompt the user that the “cube” has been currently selected.

Step 203: in response to detecting the current hand motion information, performing movement control processing on the target object according to the current hand motion information.

In an embodiment of the present disclosure, the movement control processing is performed on the target object according to the current hand motion information, so that the movement of the user's hand may drive the movement of the target object visually, and the experience of moving and interacting with the target object in the extended reality space is greatly improved.

The current hand motion information may be periodically determined according to a preset detection period, that is, the current hand motion information may be understood as a motion situation of the user's hand relative to the user's hand detected last time in a current detection period.

It should be noted that in different application scenes, the modes of performing movement control processing on the target object according to the current hand motion information are different. When the hand posture changes from the preset selection gesture to the preset selection confirmation gesture, the change in the display position of the target object is controlled according to the movement of the user's hand, so that an effect of controlling the movement of the target object by the hand is implemented visually.

The following describes embodiments with examples, where the embodiments may be performed separately or in combination, that is, the movement control methods among different embodiments can be performed together. The following only describes each possible embodiment separately.

In some possible embodiments, the motion information of the hand on the vertical plane is obtained according to the current hand motion information, and when the motion information includes the first displacement information, the target object is controlled to move according to the first displacement information. The vertical plane is perpendicular to the eyesight direction of the user in the extended reality space, that is, the plane facing the eyesight of the user is the vertical plane (usually the xy plane in the extended reality space). That is, in this embodiment, the target object is controlled to move according to the first displacement information in response to obtaining the first displacement information, where the first displacement information includes a moving distance, a moving direction, and the like. In this embodiment, the target object moves on the vertical plane with the left and right movement of the user's hand, and an effect that the hand “pulls” the target object to move is implemented visually.

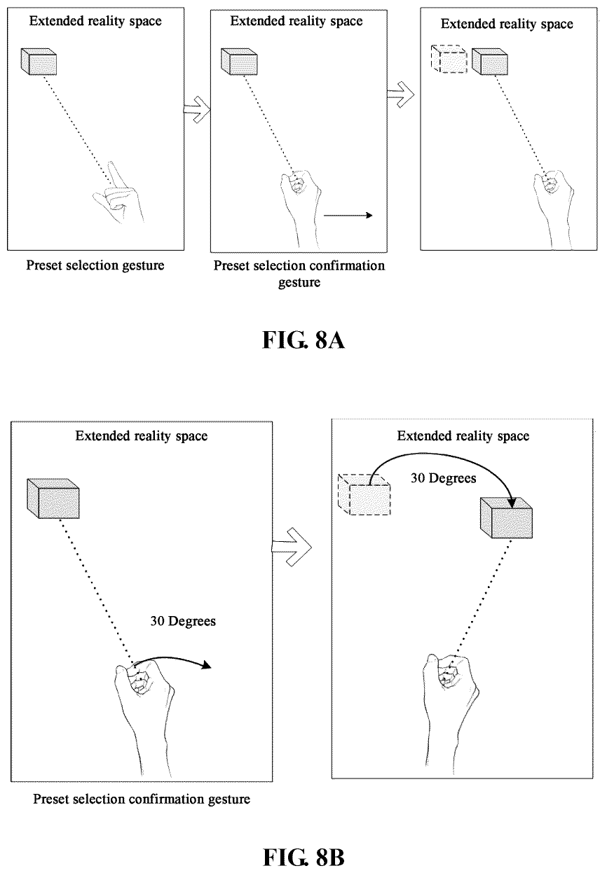

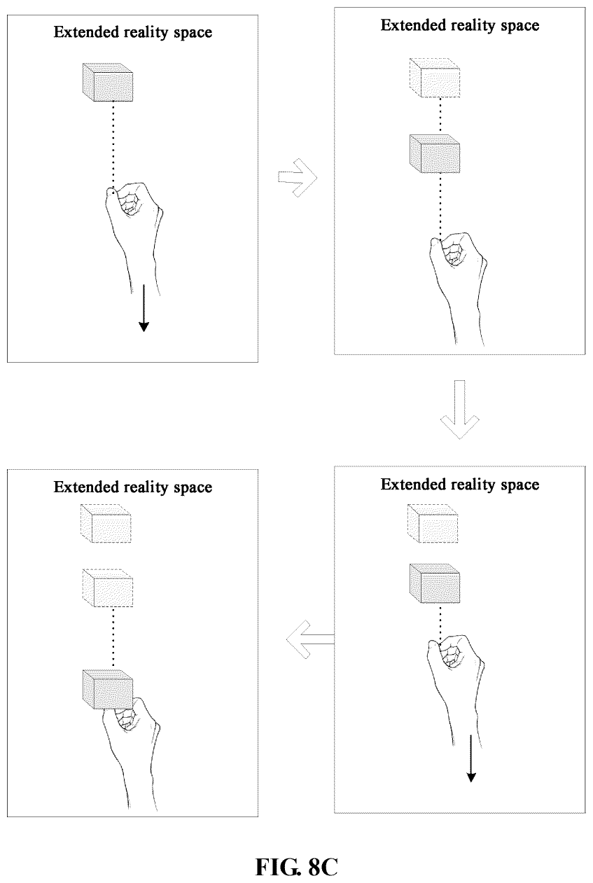

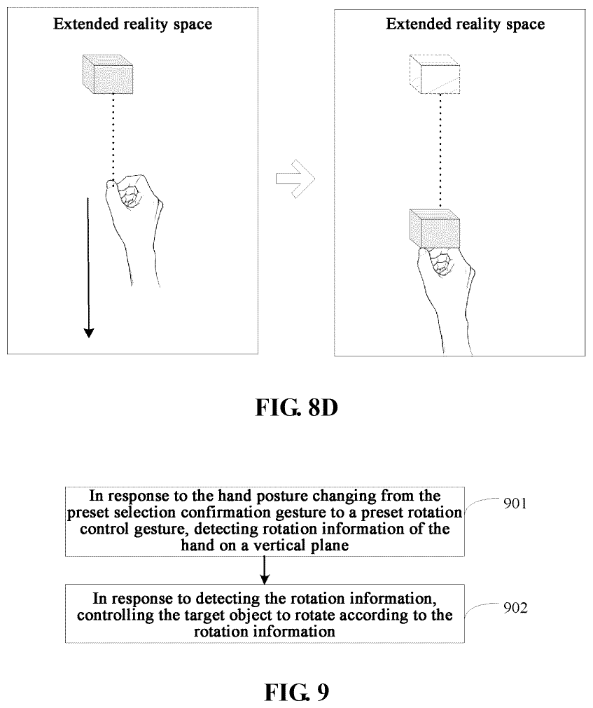

For example, if the preset selection confirmation gesture is as shown in FIG. 8A, the current hand motion information of the user is detected, and if the current hand motion information is moving to the right on the vertical plane, the corresponding target object is controlled to move to the right accordingly.

In some possible embodiments, the motion information of the hand on the vertical plane is obtained according to the current hand motion information, where the vertical plane is perpendicular to the eyesight direction of the user in the extended reality space. When the motion information includes the rotation angle, the target object is controlled to rotate according to the rotation angle with the hand as the rotation center. That is, in this example, even if the user's hand does not move but rotates in place in the preset selection confirmation gesture, the change in the display position of the target object can be controlled.

For example, if the preset selection confirmation gesture is as shown in FIG. 8B, the current hand motion information of the user is detected, and when the motion information includes a rotation angle, for example, the user's hand rotates 30 degrees to the right, the target object is controlled to rotate 30 degrees to the right with the hand of the user as the rotation center, so that an effect of “flying a kite” type bare hand control of the target object is implemented visually.

In some possible embodiments, the speed of the target object moving towards the user's hand can be controlled according to the hand motion information. In this embodiment, the second displacement information of the hand in the depth direction and the motion speed information may be obtained according to the current hand motion information, where the depth direction is consistent with the eyesight direction of the user, that is, the depth direction may be understood as the z-axis direction in the extended reality space. The movement control processing is performed on the target object according to the second displacement information and the motion speed information. That is, in this embodiment, in addition to the movement of the target object on the xy-axis, the movement control of the target object on the z-axis can also be implemented, and the multi-axis movement control gives the user a strong “sense of technology” object movement effect visually.

In the actual execution process, when the motion speed information satisfies the preset uniform motion condition (for example, if the motion acceleration is less than the preset acceleration threshold, it is considered that the preset allowable motion condition is satisfied), the target object is controlled to move at a constant speed according to the second displacement information and the motion speed information.

For example, as shown in FIG. 8C, when the motion of the hand in the depth direction is obtained according to the currently detected current hand motion information, if the hand is moving at a constant speed, the target object is controlled to move in the direction of the hand at a constant speed according to the second displacement information. When the current hand motion information detected next time is obtained, if the current hand motion information detected next time also corresponds to the motion of the hand in the depth direction and the hand is moving at a constant speed, the target object is controlled to move further in the direction of the hand at a constant speed according to the second displacement information. Thus, the user may realize the visual effect that the target object approaches the hand at a constant speed through the continuous and repeated “dragging” motion of the hand. The moving speed of the target object may be directly proportional to the motion speed information of the hand, and the effect that the target object gradually moves to the hand with the continuous “dragging” motion of the user's hand is implemented visually.

When the motion speed information satisfies the preset acceleration motion condition (for example, if the motion acceleration is greater than or equal to the preset acceleration threshold, it is considered that the preset acceleration motion condition is satisfied), the first current hand position is determined, and the target object is controlled to accelerate to reach or directly switch to the first current hand position for display, that is, the visual effect that the object quickly reaches the position where the user's hand is located is implemented visually.

For example, as shown in FIG. 8D, when the motion of the hand in the depth direction is obtained according to the currently detected current hand motion information, if the hand is in an accelerated motion, the target object is controlled to switch from the current display position to the first current hand position for display, that is, the visual effect that the object quickly reaches the hand when the hand of the user is in an accelerated motion is implemented, and the effect of “instant grabbing” of the target object is implemented.

Of course, the hand motions in the depth direction mentioned in the above embodiments are all cases of moving towards the outside of the extended reality space. In some possible embodiments, when the hand motion is moving towards the inside of the extended reality space, when the motion speed information satisfies the preset uniform motion condition, the target object is controlled to move at a constant speed in a direction away from the hand according to the second displacement information and the motion speed information; and when the motion speed information satisfies the preset acceleration motion condition, the target object is controlled to accelerate to move in the direction away from the hand.

Therefore, in the embodiments of the present disclosure, various kinds of movement control of the target object can be implemented based on the change in the hand posture of the user's hand and the hand motion information, including the movement control of the target object in the three axes of x, y, and z, implementing the visual effect that the user's hand “pulls” the target object to display with “bare hands”. This control method may be applied to scene construction in a “game scene”. Therefore, the process of displaying the target object from being selected to moving may be implemented through the gesture operation, without operating the handle device, etc., which expands the operation methods in the extended reality scene and improves the intelligence of the operation.

In summary, in the method for object movement control provided in the embodiments of the present disclosure, in response to a hand posture in an extended reality space being a preset selection gesture, a target object corresponding to the preset selection gesture is determined in the extended reality space; in response to the hand posture changing from the preset selection gesture to a preset selection confirmation gesture, current hand motion information is detected; and in response to detecting the current hand motion information, movement control processing is performed on the target object according to the current hand motion information. In the embodiments of the present disclosure, the movement of the object is controlled according to the hand posture and hand movement, the “bare hand” control to the object is implemented, the flexibility of object movement control is improved, and the interaction experience in the extended reality space is improved.

Based on the above embodiments, in order to meet the movement requirements of the target object in more scenes, diversified and flexible movement control of the target object can also be implemented based on richer gestures and hand movements.

In an embodiment of the present disclosure, as shown in FIG. 9, the above method for controlling object movement further includes the following steps.

Step 901: in response to the hand posture changing from the preset selection confirmation gesture to a preset rotation control gesture, detecting rotation information of the hand on a vertical plane.

The preset rotation control gesture may be any predefined gesture for identifying “rotation” control.

In an embodiment of the present disclosure, in response to detecting that the hand posture changes from the preset selection confirmation gesture to the preset rotation control gesture, the rotation information of the hand on the vertical plane may be detected, where the rotation information includes a rotation angle and the like. That is, in this embodiment, in response to detecting that the hand posture changes from the preset selection confirmation gesture to the preset rotation control gesture, coordinates of a center point of the target object on the xy-axis are “locked”, and the target object is controlled to move in a manner of rotating in place. A specific rotation angle and the like are determined according to the rotation information of the hand on the vertical plane, where the rotation information includes one or more of a rotation speed, a rotation angle, a rotation direction, and the like.

Step 902: in response to detecting the rotation information, controlling the target object to rotate according to the rotation information.

In response to detecting the rotation information, the target object is controlled to rotate according to the rotation information, so that a visual effect that the target object rotates in place is implemented. When the target object is rotating, a center point of the target object may be used as a rotation center.

Further, in an embodiment of the present disclosure, in response to detecting that the hand posture changes from the preset rotation control gesture to the preset release gesture, and the preset release gesture is a predefined gesture for identifying “releasing” the target object, an initial display direction of the target object which is before rotation is determined, and the target object is controlled to be displayed according to the initial display direction, that is, the target object is controlled to be “rotated to zero” visually.

In some possible embodiments, in order to avoid the impact of the interaction experience caused by a relatively long distance from the target object, the real-time hand position of the hand may also be detected, and the preset association model of the target object is displayed at the corresponding real-time hand position. The preset association model may be a “scaled-down” model of the target object or any other preset model corresponding to the target object, such as only a “sphere” model. Usually, the preset association model has a corresponding relationship with the target object visually, and the user may visually feel that the preset association model is a “shadow” model of the target object.

In order to strengthen the association relationship between the preset association model and the target object visually, during the entire process of “dragging and rotating” movement, the association animation between the preset association model and the target object is displayed in real time. The association animation can be flexibly set according to the requirements of the scene, and may be, for example, a “mapping projection” animation or a “bubble emission” animation.

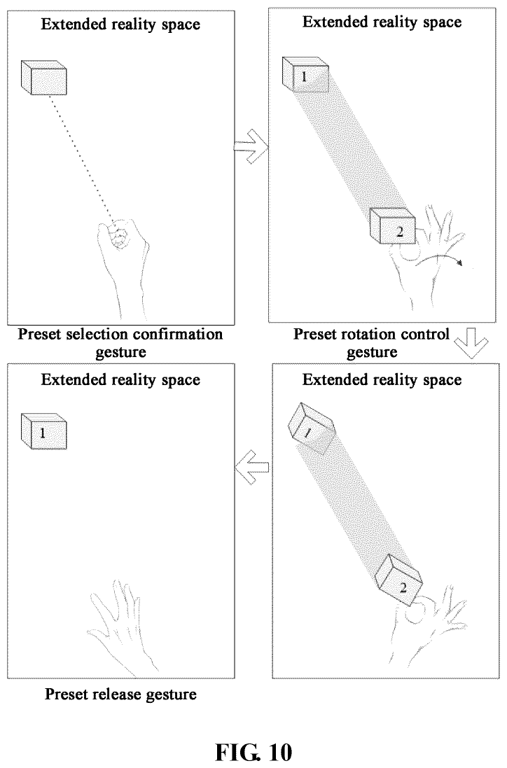

For example, as shown in FIG. 10, the target object is “cube 1”, and the preset rotation control gesture is that the index finger and the thumb are “pinched” and the other three fingers are spread. In response to the hand posture changing from the preset selection confirmation gesture to the preset rotation control gesture, the preset association model of the target object is displayed at the corresponding real-time hand position following the real-time hand position of the user's hand. The preset association model is “cube 2” on a scaled-down scale in the figure. An association animation is displayed between “cube 1” and “cube 2”, and the association animation in the figure is a “mapping animation” between “cube 1” and “cube 2”, so as to achieve a visual effect that a distant object may be operated while an object in the hand is manipulated. In the figure, the transparency of “cube 1” in the rotation state is relatively high, and “cube 1” is “highlighted” in the selected state.

After detecting that the hand posture of the user's hand changes from the preset rotation control gesture to the preset release gesture, the “mapping animation” and the “cube 2” are no longer displayed, and the “cube 1” is restored to the initial display state (including the initial display direction). This initial state may be understood as the display state of the “cube 1” before the rotation control of the preset rotation control gesture.

Alternatively, after detecting that the hand posture of the user's hand changes from the preset rotation control gesture to the preset release gesture, the “mapping animation” and the “cube 2” are no longer displayed, and the display of the “cube 1” is controlled to be a display state after the rotation control of the preset rotation control gesture.

In an embodiment of the present disclosure, in response to detecting that the hand posture changes from the preset rotation control gesture to the preset retraction gesture, where the preset retraction gesture is a predefined gesture for identifying “retracting”, a second current hand position of the hand is determined, and the target object is controlled to switch to the second current hand position for display, that is, the visual effect of “retracting to hand for display” of the target object may be implemented through the preset retraction gesture.

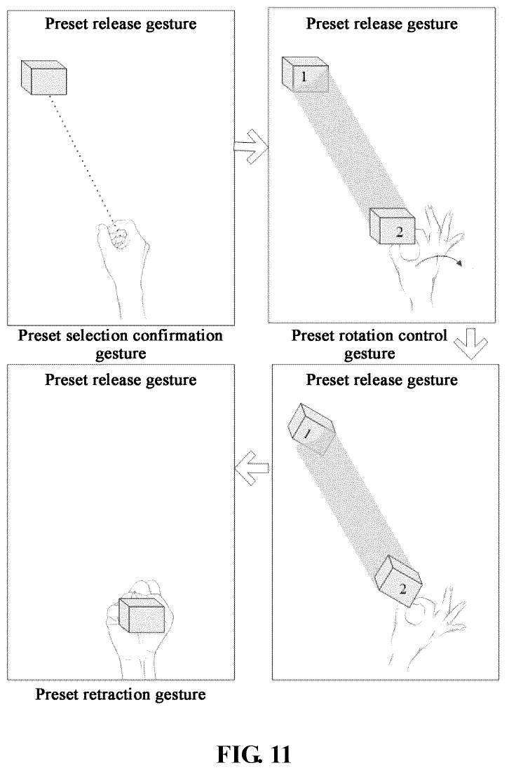

For example, still taking the scene shown in FIG. 10 as an example, as shown in FIG. 11, in response to the hand posture changing from the preset rotation control gesture to the preset retraction gesture (the five fingers are retracted and curled up in the figure), the target object may be moved to the second current hand position of the user for display, for example, “cube 2” may be displayed in a solid form, and the “cube” in the distance disappears.

In summary, in the method for object movement control provided in the embodiments of the present disclosure, more diversified movement control such as rotation and retraction of the target object may be implemented based on rich gestures and hand movements, which further improves the experience of controlling the target object in the extended reality space.

In order to implement the above embodiments, the present disclosure further proposes an apparatus for object movement control.

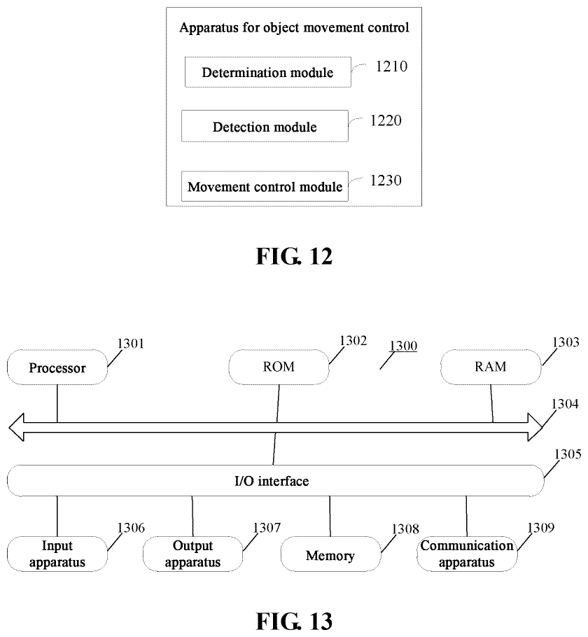

FIG. 12 is a schematic structural diagram of an apparatus for object movement control according to an embodiment of the present disclosure. The apparatus may be implemented in software and/or hardware and may generally be integrated into an electronic device for object movement control. As shown in FIG. 12, the apparatus includes a determination module 1210, a detection module 1220, and a movement control module 1230.

The determination module 1210 is configured to determine, in response to a hand posture in an extended reality space being a preset selection gesture, a target object corresponding to the preset selection gesture in the extended reality space;

The detection module 1220 is configured to detect current hand motion information in response to the hand posture changing from the preset selection gesture to a preset selection confirmation gesture; and The movement control module 1230 is configured to perform movement control processing on the target object according to the current hand motion information in response to detecting the current hand motion information.

The apparatus for object movement control provided in the embodiments of the present disclosure may perform the method for object movement control provided in any embodiment of the present disclosure, and has corresponding functional modules and beneficial effects for performing the method. The implementation principle is similar to that in the embodiments of the object control method, and will not be repeated here.

In order to implement the above embodiments, the present disclosure further proposes a computer program product, including a computer program/instructions, which, when executed by a processor, implement the method for object movement control in the above embodiments.

FIG. 13 is a schematic structural diagram of an electronic device according to an embodiment of the present disclosure.

Reference is made to FIG. 13 below, which illustrates a schematic structural diagram of an electronic device 1300 suitable for implementing an embodiment of the present disclosure. The electronic device 1300 in the embodiment of the present disclosure may include, but is not limited to, mobile terminals such as mobile phones, notebooks, digital broadcast receivers, PDAs (personal digital assistants), PADs (tablet computers), PMPs (portable multimedia players), and in-vehicle terminals (such as in-vehicle navigation terminals), and fixed terminals such as digital TVs and desktop computers. The electronic device shown in FIG. 13 is only an example and should not bring any limitation to functions and usage scopes of the embodiments of the present disclosure.

As shown in FIG. 13, the electronic device 1300 may include a processor (e.g., a central processing unit, a graphics processing unit, etc.) 1301 that may perform various appropriate actions and processes according to a program stored in a read-only memory (ROM) 1302 or a program loaded from a memory 1308 into a random access memory (RAM) 1303. Various programs and data required for the operation of the electronic device 1300 are also stored in the RAM 1303. The processor 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touchscreen, a touch pad, a keyboard, a mouse, a camera, a microphone, an accelerometer, and a gyroscope; an output apparatus 1307 including, for example, a liquid crystal display (LCD), a speaker, and a vibration; a memory 1308 including, for example, a magnetic tape and a hard disk; and a communication apparatus 1309. The communication apparatus 1309 may allow the electronic device 1300 to perform wireless or wired communication with other devices to exchange data. Although FIG. 13 shows the electronic device 1300 with various apparatuses, it should be understood that it is not required to implement or have all of the illustrated apparatuses. More or fewer apparatuses may alternatively be implemented or provided.

In particular, according to the embodiments of the present disclosure, the processes described above with reference to the flowcharts may be implemented as a computer software program. For example, the embodiments of the present disclosure include a computer program product, which includes a computer program carried on a non-transitory computer-readable medium, and the computer program includes program codes for performing the method shown in the flowcharts. In such an embodiment, the computer program may be downloaded and installed from the network through the communication apparatus 1309, or installed from the memory 1308, or installed from the ROM 1302. When the computer program is executed by the processor 1301, the above functions defined in the method for object movement control of the embodiments of the present disclosure are performed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that can be used by or in combination with an instruction execution system, apparatus, or device. In the present disclosure, the computer-readable signal medium may include a data signal propagated in a baseband or as a part of a carrier, in which computer-readable program codes are carried. This propagated data signal can take various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium can be transmitted by any suitable medium, including but not limited to: electric wires, optical cables, radio frequency (RF), etc., or any suitable combination thereof.

In some implementations, the client and the server can communicate using any currently known or future-developed network protocols, such as HTTP (HyperText Transfer Protocol), and can be interconnected with digital data communication (for example, a communication network) in any form or medium. Examples of communication networks include local area networks (“LANs”), wide area networks (“WANs”), the Internet, and end-to-end networks (for example, ad hoc end-to-end networks), as well as any currently known or future-developed networks.

The above computer-readable medium may be included in the above electronic device, or may exist alone without being assembled into the electronic device.

The above computer-readable medium carries one or more programs, and when the one or more programs are executed by the electronic device, the electronic device is caused to: in response to a hand posture in an extended reality space being a preset selection gesture, determine a target object corresponding to the preset selection gesture in the extended reality space; in response to the hand posture changing from the preset selection gesture to a preset selection confirmation gesture, detect current hand motion information; and in response to detecting the current hand motion information, perform movement control processing on the target object according to the current hand motion information. In the embodiments of the present disclosure, the movement of the object is controlled according to the hand posture and hand movement, the “bare hand” control of the object is implemented, the flexibility of object movement control is improved, and the interaction experience in the extended reality space is improved.

The computer program codes for performing the operations of the present disclosure may be written in one or more programming languages or a combination thereof. The preceding programming languages include object-oriented programming languages such as Java, Smalltalk, and C++and may also include conventional procedural programming languages such as C or similar programming languages. The program codes may be executed entirely on a user computer, executed partly on a user computer, executed as a stand-alone software package, executed partly on a user computer and partly on a remote computer, or executed entirely on a remote computer or a server. In the case of a remote computer, the remote computer may be connected to the user computer via any type of network, including a local area network (LAN) or a wide area network (WAN), or the connection may be made to an external computer (for example, via the Internet through an Internet service provider).

The flowcharts and block diagrams in the drawings show possible architectures, functions, and operations of the system, method, and computer program product according to various embodiments of the present disclosure. In this regard, each block in the flowcharts or block diagrams may represent a module, a program segment, or part of codes that contains one or more executable instructions for implementing specified logical functions. It is also to be noted that in some alternative implementations, the functions noted in the blocks may occur in an order different from that noted in the drawings. For example, two blocks shown in succession may, in fact, be executed substantially concurrently, or the blocks may sometimes be executed in a reverse order, depending upon the functionality involved. It is also to be noted that each block of the block diagrams and/or flowcharts and combinations of blocks in the block diagrams and/or flowcharts may be implemented by a special-purpose hardware-based system that performs the specified functions or operations or may also be implemented by a combination of special-purpose hardware and computer instructions.

The units involved in the embodiments of the present disclosure may be implemented by software or hardware. The name of the unit does not constitute a limitation on the unit itself under certain circumstances.

The functions described herein above may be performed, at least partially, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is merely a description of the preferred embodiments of the present disclosure and an explanation of the technical principles employed. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the above disclosed concept. For example, a technical solution formed by replacing the above features with technical features having similar functions disclosed in the present disclosure (but not limited to).

In addition, although operations are depicted in a specific order, this should not be understood as requiring these operations to be performed in a specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely example forms for implementing the claims.

1. A method for object movement control, comprising:
in response to a hand posture in an extended reality space being a preset selection gesture, determining a target object corresponding to the preset selection gesture in the extended reality space;
in response to the hand posture changing from the preset selection gesture to a preset selection confirmation gesture, detecting current hand motion information; and
in response to detecting the current hand motion information, performing movement control processing on the target object according to the current hand motion information.

2. The method according to claim 1, wherein the determining the target object corresponding to the preset selection gesture in the extended reality space comprises:
in response to the hand posture being the preset selection gesture, displaying a direction indication model in the extended reality space, wherein the direction indication model is used for indicating a hand control direction of the hand posture; and
determining a control object located in the hand control direction indicated by the direction indication model to be the target object.

3. The method according to claim 1, wherein the performing movement control processing on the target object according to the current hand motion information comprises:
obtaining motion information of a hand on a vertical plane according to the current hand motion information, wherein the vertical plane is perpendicular to an eyesight direction of a user in the extended reality space; and
in response to obtaining the motion information, in a case that the motion information comprises first displacement information, controlling the target object to move according to the first displacement information, and/or
in a case that the motion information comprises a rotation angle, controlling the target object to rotate according to the rotation angle with the hand as a rotation center.

4. The method according to claim 1, further comprising:
obtaining second displacement information of the hand in a depth direction and motion speed information according to the current hand motion information, wherein the depth direction is consistent with an eyesight direction of a user; and
performing movement control processing on the target object according to the second displacement information and the motion speed information.

5. The method according to claim 4, wherein the performing movement control processing on the target object according to the second displacement information and the motion speed information comprises:
controlling the target object to move at a constant speed according to the second displacement information and the motion speed information in response to the motion speed information satisfying a preset uniform motion condition; and
determining a first current hand position in response to the motion speed information satisfying a preset acceleration motion condition, and controlling the target object to accelerate to reach or switch to the first current hand position for display.

6. The method according to claim 1, further comprising:
in response to the hand posture changing from the preset selection confirmation gesture to a preset rotation control gesture, determining a current center point position of the target object;
detecting rotation information of the hand on the vertical plane; and
in response to detecting the rotation information, controlling the target object to rotate according to the rotation information with the current center point position as a rotation center.

7. The method according to claim 6, further comprising:
detecting a real-time hand position of the hand in response to the hand posture being the preset rotation control gesture, and displaying a preset association model of the target object at the corresponding real-time hand position,
wherein an association animation for the preset association model and the target object is displayed between the preset association model and the target object in real time.

8. The method according to claim further comprising:
in response to the hand posture changing from the preset rotation control gesture to a preset release gesture, determining an initial display direction of the target object before rotation; and
controlling the target object to be displayed according to the initial display direction.

9. The method according to claim 6, further comprising:
in response to the hand posture changing from the preset rotation control gesture to a preset retraction gesture, determining a second current hand position of the hand; and
controlling the target object to switch to the second current hand position for display.

10. (canceled)

11. An electronic device, comprising:
a processor;
a memory, configured to store instructions executable by the processor; and
the processor, configured to read the executable instructions from the memory and execute the executable instructions to:
in response to a hand posture in an extended reality space being a preset selection gesture, determine a target object corresponding to the preset selection gesture in the extended reality space;
in response to the hand posture changing from the preset selection gesture to a preset selection confirmation gesture, detect current hand motion information; and
in response to detecting the current hand motion information, perform movement control processing on the target object according to the current hand motion information.

12. non-transitory computer-readable storage medium, wherein a computer program is stored in the computer-readable storage medium, and the computer program is configured to:
in response to a hand posture in an extended reality space being a preset selection gesture, determine a target object corresponding to the preset selection gesture in the extended reality space;
in response to the hand posture changing from the preset selection gesture to a preset selection confirmation gesture, detect current hand motion information; and
in response to detecting the current hand motion information, perform movement control processing on the target object according to the current hand motion information.

13. (canceled)

14. The device according to claim 11, wherein the instructions causing the processor to determine the target object corresponding to the preset selection gesture in the extended reality space comprises instructions causing the processor to:
in response to the hand posture being the preset selection gesture, display a direction indication model in the extended reality space, wherein the direction indication model is used for indicating a hand control direction of the hand posture; and
determine a control object located in the hand control direction indicated by the direction indication model to be the target object.

15. The device according to claim 11, wherein the instructions causing the processor to perform movement control processing on the target object according to the current hand motion information comprises instructions causing the processor to:
obtain motion information of a hand on a vertical plane according to the current hand motion information, wherein the vertical plane is perpendicular to an eyesight direction of a user in the extended reality space; and
in response to obtaining the motion information, in a case that the motion information comprises first displacement information, control the target object to move according to the first displacement information, and/or
in a case that the motion information comprises a rotation angle, control the target object to rotate according to the rotation angle with the hand as a rotation center.

16. The device according to claim 11, wherein the device is further caused to:
obtain second displacement information of the hand in a depth direction and motion speed information according to the current hand motion information, wherein the depth direction is consistent with an eyesight direction of a user; and
perform movement control processing on the target object according to the second displacement information and the motion speed information.

17. The device according to claim 16, wherein the instructions causing the processor to perform movement control processing on the target object according to the second displacement information and the motion speed information comprises instructions causing the processor to:
control the target object to move at a constant speed according to the second displacement information and the motion speed information in response to the motion speed information satisfying a preset uniform motion condition; and
determine a first current hand position in response to the motion speed information satisfying a preset acceleration motion condition, and control the target object to accelerate to reach or switch to the first current hand position for display.

18. The device according to claim 11, wherein the device is further caused to:
in response to the hand posture changing from the preset selection confirmation gesture to a preset rotation control gesture, determine a current center point position of the target object;
detect rotation information of the hand on the vertical plane; and
in response to detecting the rotation information, control the target object to rotate according to the rotation information with the current center point position as a rotation center.

19. The device according to claim 17, wherein the device is further caused to:
detect a real-time hand position of the hand in response to the hand posture being the preset rotation control gesture, and display a preset association model of the target object at the corresponding real-time hand position,
wherein an association animation for the preset association model and the target object is displayed between the preset association model and the target object in real time.

20. The device according to claim 18, wherein the device is further caused to:
in response to the hand posture changing from the preset rotation control gesture to a preset release gesture, determine an initial display direction of the target object before rotation; and
control the target object to be displayed according to the initial display direction.

21. The device according to claim 18, wherein the device is further caused to:
in response to the hand posture changing from the preset rotation control gesture to a preset retraction gesture, determine a second current hand position of the hand; and
control the target object to switch to the second current hand position for display.

22. The medium according to claim 12, wherein the computer program configured to determine the target object corresponding to the preset selection gesture in the extended reality space comprises computer program configured to:
in response to the hand posture being the preset selection gesture, display a direction indication model in the extended reality space, wherein the direction indication model is used for indicating a hand control direction of the hand posture; and
determine a control object located in the hand control direction indicated by the direction indication model to be the target object.
